(19) United States
(12) Patent Application Publication
(10) Pub. No.: US 2006/0058989 A1
(43) Pub. Date: Mar. 16, 2006

(54) Symbolic model checking of generally asynchronous hardware

(75) Inventors: Sharon Keidar-Barner, Yokne'am Ilit (IL); Ishai Rabinovitz, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/939,734

(22) Filed: Sep. 13, 2004

(51) Int. Cl. G06F 17/50

(52) U.S. Cl. 703/13

(57) ABSTRACT

A model checker includes a model checker to generate a model of a piece of generally asynchronous hardware in which the set of variables includes a separate process chooser variable and the remainder of the variables are divided into disjoint sets of groups. At each cycle of the model, the process chooser and maximally, variables from one group of variables change values.

### FIELD OF THE INVENTION

The present invention relates to symbolic model checking generally and to symbolic model checking for hardware in particular.

### BACKGROUND OF THE INVENTION

Modern design of very large-scale integrated circuits and of complex software and hardware systems often involves years of research and the efforts of hundreds of engineers. Automated formal verification methods may be an essential part of the design effort, reducing errors, lost time and risk to financial investment. Formal verification involves building a finite model of a system as a group of states and state transitions and checking that a desired property holds in the model. An exhaustive search of all possible states of the model may be performed in order to verify a desired property.

As the size and complexity of designs increase, much effort may be expended to improve the efficiency of automated formal verification methods. One technique used in symbolic model checking to improve efficiency is to employ binary decision diagrams (BDDs). A BDD is a directed acyclic graph that represents a Boolean expression. FIG. 1, to which reference may be now briefly made, shows an exemplary BDD for the expression ((a1 iff a2) and (b1 iff b2)), where “iff” stands for “if and only if”. Each circle indicates a variable (a1, a2, b1, b2) and the lines indicate the directions to follow when the variable has a value of 0 (dashed lines) or 1 (solid lines). For each BDD, there may be two terminal nodes 8 representing the result of the Boolean expression.

Boolean operations performed on a BDD are a polynomial function of the size of the BDD. While BDDs are generally a compact representation of a Boolean expression, they can be exponential in the size of the expression they are representing. In addition, the size of the BDD is significantly affected by the order in which the variables of the expression are listed.

One method for symbolic model checking using BDDs comes from Carnegie Mellon University and is known as the Symbolic Model Verifier (SMV). A good discussion of symbolic model checking may be found in the introduction to the online paper “NuSMV: a new symbolic model checker” by A. Cimatti et al., which can be found in 2003 at the website: nusmv. irst. itc. it/NuSMV/papers/sttt_j/html/paper.html. Another model checker may be Rulebase, commercially available from International Business Machines Inc. (IBM) of the USA, which includes in it a symbolic model checker. The input language to the RuleBase model checker is EDL (Environment Description Language).

The article by C. Eisner, “Using Symbolic CTL Model Checking to Verify the Railway Stations of Hoorn-Kersenboogerd and Heerhugowaard”, Software Tools for Technology Transfer, Vol. 4, number 1 pp. 107-124, includes a nice tutorial on the process of symbolic model checking.

One of the important functions of symbolic model checkers is to determine which group RS of states of a model may be reached from an initial group S₀ of states and which cannot be reached. This is known as “reachability”. FIG. 2, to which reference is now briefly made, is an illustration of a state machine 12 with six states, A, B, C, D, E and F, of which A and B are the initial states. Each state represents one particular set of assignments of three state variables (v₁, v₂, v₃) forming a state vector \overline{v}. Thus, for example, state A is the state with the values (0,0,0) while state C is the state with the values (1,0,1).

State machine 12 moves through the states as indicated by the arrows on FIG. 2. Thus, state machine 12 may remain at state A or it may proceed to state C and from there to state E or it may begin at state B and move to state D. This movement through the groups of state is defined, in symbolic model checking, by a “transition relation” R from one state vector \overline{v} to a “next” state vector \overline{v}′. For state machine 12, transition relation R is:

$$R ( \overline{v} , {\overline{v}}^{′} ) = \{ \begin{matrix}( 000 \text{,} 000 ) \\ ( 000 \text{,} 101 ) \\ ( 011 \text{,} 001 ) \\ ( 101 \text{,} 111 ) \\ ( 110 \text{,} 011 )\end{matrix} \}$$

From the initial group S₀ of states {A, B}, the state machine may get to the group S₁ of states {A,C,D} in one step. State A has already been explored and thus, the next step is to explore states C and D. From the group {C,D}, the state machine can get to the group S₂ comprised of state E. Since state E has no outward going arrow, the model checker is finished. From these results, the reachable states are A,B,C, D and E. State F is not reachable from any of the initial states.

A model checker may operate on the graph of FIG. 1 and may follow the arrows, looking for states. A symbolic model checker may perform its checking through use of a symbolic representation of the graph, rather than the graph itself.

The model described above is a Kripke structure M defined over a set of atomic propositions AP. Mathematically, this is written:
M=(S, S₀, R, L)
where L is a labeling function that labels each state S with the set of atomic propositions that are true in that state S. The states of the Kripke structure are coded by the group of state variables \overline{v}.

The basic operations in symbolic model checking may be the image computation and the pre-image computation. The image computation of Sᵢ uses transition relation R to move to the next group of states Sᵢ₊₁. The pre-image computation of Sᵢ uses transition relation R to take a step backwards to the group of states Sᵢ₋₁.

More precisely:
image(S(\overline{v}), R(\overline{v},\overline{v}′))=∃\overline{v}(S(\overline{v}) [symbol] R(\overline{v},\overline{v}′))
and
pre_{—}image(S(\overline{v}′), R(\overline{v},\overline{v}′))=∃\overline{v}′(S(\overline{v}′) [symbol] R(\overline{v},\overline{v}′))
where S(\overline{v}) is a logical predicate over \overline{v} and S(\overline{v}) and R(\overline{v}, \overline{v}′) are BDDs representing a group of states S and a transition relation R, respectively, ∃ is the ‘exist’ function and [symbol] is the ‘and’ function. Computing ∃xA(\overline{v}) may be referred to as “quantifying x out of A”. A “conjunctive partitioned transition relation” may be composed of a set of partitions and _Rᵢ such that, when they are ‘anded’ together, they produce the transition relation R(\overline{v},\overline{v}′), or, mathematically:
R(\overline{v},\overline{v}′)= [symbol] ᵢ and _Rᵢ(\overline{v},\overline{v}′)

If each state variable vᵢ can be described by a single conjunctive partition, then and _Rᵢ=(v′ᵢ=fᵥ_{ᵢ}(\overline{v})) and thus, each partition may be a function of the current set of variables \overline{v} and \overline{v}′ (the ith next step variable) rather than the current and next step sets of variables, \overline{v} and \overline{v}′, respectively. The image computation in this case is:
image(S(\overline{v}))=∃\overline{v}(S(\overline{v}) [symbol] ( [symbol] ᵥ_{ᵢ} and _{—}Rᵥ_{ᵢ}(\overline{v},vᵢ′)))

Early existential quantification may make image and pre-image computations more efficient by reducing the size of the BDD. This is discussed in the article: D. Geist and I. Beer. Efficient Model Checking By Automated Ordering Of Transition Relation Partitions. In Proc. 6^{th} International Conference on Computer Aided Verification (CAV), LNCS 818, pages 299-310. Springer-Verlag, 1994.

A “disjunctive partitioned transition relation” may be composed of a set of partitions or _Rᵢ such that, when they are “or'ed” together, they produce the transition relation R(\overline{v},\overline{v}′), or, mathematically:
R(\overline{v}, \overline{v}′)=vᵢ or _Rᵢ(\overline{v},\overline{v}′)

If each current state variable vᵢ can be changed only in a single disjunctive partition, then or _Rᵥ_{ᵢ}=(vᵢ′=fᵥ_{ᵢ}(\overline{v})) [symbol] (∀y≠vᵢ: y=y′). The image computation in this case is:

$$\text{image} ( S ( \overline{v} ) ) = ∃ \overline{v} ( S ( \overline{v} ) ⋀ ( {⋁}_{{v}_{i}} {or\_R}_{{v}_{i}} ( \overline{v} , {\overline{v}}^{′} ) ) )$$

Because existential quantification distributes, mathematically, over disjunction, every quantification may be performed before performing the disjunction operation and thus:

$$\text{image} ( S ( \overline{v} ) ) = {⋁}_{{v}_{i}} ∃ \overline{v} ( S ( \overline{v} ) ⋀ {or\_R}_{{v}_{i}} ( \overline{v} , {\overline{v}}^{′} ) )$$

Because quantification may be done before disjunction for every variable vᵢ in the disjunctive partitioning, all intermediate BDD results depend only on the set of next step variables \overline{v}′, while when using conjunctive partitions, the intermediate BDD results may depend both on the current and next step sets of variables, \overline{v} and \overline{v}′. Thus, using disjunctive partitions usually results in smaller intermediate BDDs than when using conjunctive partitions.

### BRIEF DESCRIPTION OF THE DRAWINGS

The subject matter regarded as the invention may be particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art binary decision diagram (BDD);

FIG. 2 is a schematic illustration of a state machine with six states;

FIG. 3A is a schematic illustration of a piece of hardware having four components, useful in understanding the model of the present invention;

FIG. 3B is a schematic illustration of a model of the hardware of FIG. 3A;

FIG. 4 is a block diagram illustration of a symbolic model checker, constructed and operative in accordance with the present invention;

FIG. 5 is a schematic illustration showing the dependent states of three variables, useful in understanding the present invention;

FIG. 6 is exemplary pseudo-code for a group definer, forming part of the model checker of FIG. 4;

FIG. 7 is exemplary pseudo-code for a disjunctive partitioner, forming part of the model checker of FIG. 4;

FIG. 8 is a schematic illustration of a disjunctive normal form, useful in understanding the present invention; and

FIGS. 9, 10, 11 and 12 are exemplary pseudo-code for a disjunctive normal form (DNF) image and pre-image calculation, useful for model checker of FIG. 4.

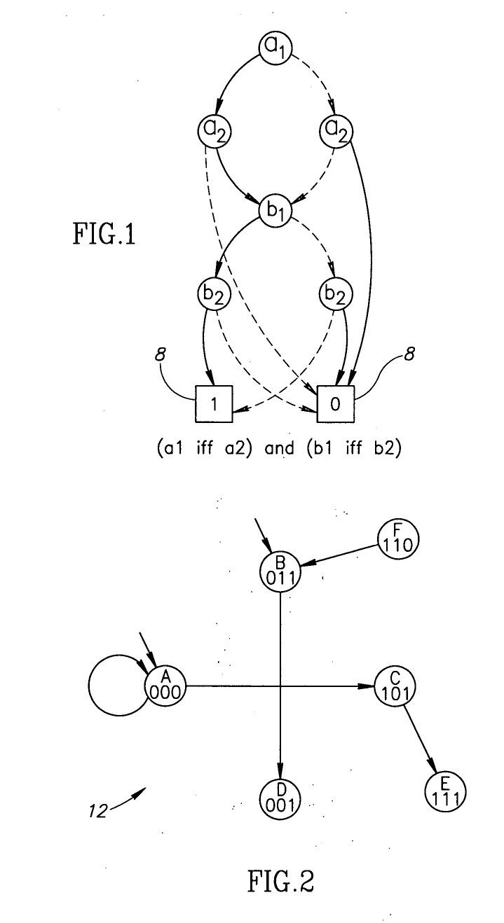

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details may be set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that many types of hardware have components that operate asynchronously to each other. Applicants have realized that such generally asynchronous hardware may be modeled by different groups of variables, where the variables of one group may change their values in the same cycle and the different groups may operate asynchronously or in different cycles to each other. The asynchronous operation may be modeled by a “process chooser” (pc) who randomly activates one group of variables.

Applicants have realized that, at any given time, only the process chooser and the activated group (or a portion of the variables therein) may change values. The remaining non-activated groups may maintain their values. Thus, there is a disjunction between the activated group and the non-activated group, which means that disjunctive partitioning may be utilized to model such types of hardware.

Since a group of variables, rather than a single variable, may be activated at a time, the disjunction may be between groups \overline{g} of state variables xᵢ. Within groups, there may be conjunction of the variables within the group. Thus, a partition known in the art as “disjunctive normal form” (DNF) may be utilized which conjoins the variables within the group but disjoins between groups. The DNF may be a “partial” DNF when utilized with partial disjunctive partitions and a standard DNF when utilized with standard disjunctive partitions.

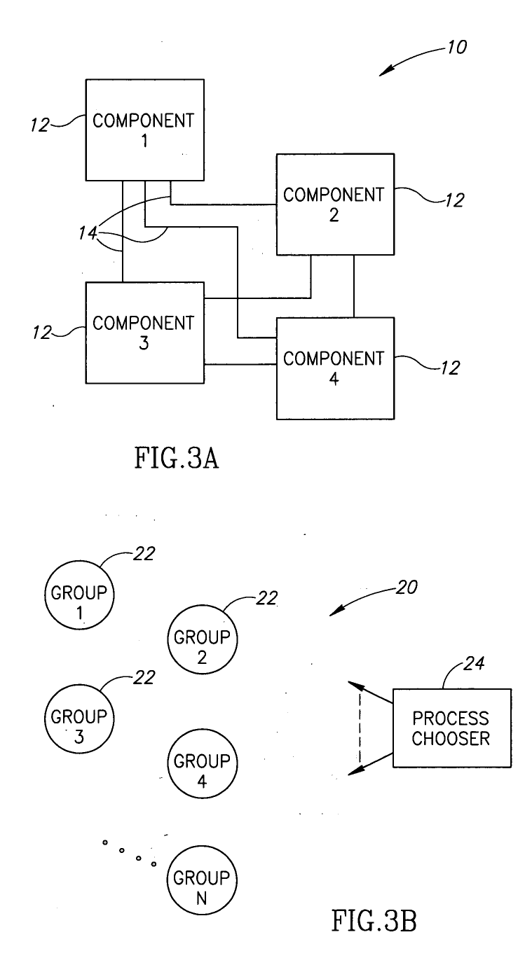

Reference is now made to FIGS. 3A and 3B, which respectively illustrate a piece of generally asynchronous hardware 10 to be modeled and an exemplary model 20 for it. Hardware 10 may comprise a multiplicity of components 12 which may be connected together via interconnects 14. In the example of FIG. 3A, there are four components 12 each of which is connected by interconnects 14 to the other three components 12.

Model 20 (FIG. 3B) may model generally asynchronous hardware 10 with a plurality of state machines 22 which work without being synchronized. In many cases, the changes in one state machine do not directly influence the variables in another state machine. In which case, model 20 may model hardware 10 as a few processes 22 that mm in parallel and a process chooser 24 which chooses which process (or state machine 22) will take the next step. Each state machine 22 may define one separate group of variables and each group 22 of variables may be modeled with a separate disjunctive partition. There may be no state machine for process chooser 24 since its behavior in the model may be nondeterministic. If there is any behavior to process chooser 24 (deterministic or otherwise), it may be modeled appropriately.

State machines 22 may be directly mapped to components 12 or each state machine may represent a portion of a component 12 or variables from more than one component 12. In all the cases, the variables included in one state machine 22 are a set of “related” variables (i.e. each variable of a group may change its value with one or more additional variables from the same group) No variables are included in a state machine that are not related to at least one of the other variables in the state machine. Independent variables may be placed into separate state machines.

One exemplary type of hardware which the present invention may model may be hardware operating with low power. In general, designers of low power hardware attempt to save power by minimizing the number of times elements, such as a latch, change their values. It may be possible to break such a design into groups of variables where two variables from different groups may not be changed in the same cycle.

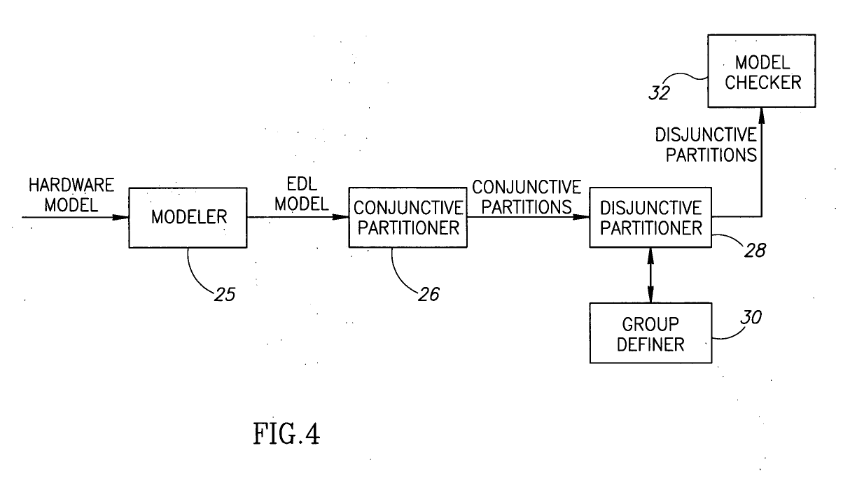

Reference is now briefly made to FIG. 4, which illustrates a model checking system, constructed and operative in accordance with the present invention.

The system of FIG. 4 may comprise a modeler 25, a conjunctive partitioner 26, a disjunctive partitioner 28, a group definer 30 and a model checker 32. A hardware model designer may generate a hardware model for hardware 10 to be checked. Modeler 25 may convert the hardware model from a standard hardware modeling language, such as the VHDL or Verilog modeling languages, to a model checker language, such as the EDL modeling language. The latter is utilized by the RuleBase model checking system. Conjunctive partitioner 26, may produce conjunctive partitions from the model checker model, such as the EDL model. Partitioner 26 may also perform BDD reductions, thereby to produce smaller partitions.

Disjunctive partitioner 28 may utilize group definer 30 to generate groups 22 of variables and may produce disjunctive partitions, described in more detail hereinbelow, from the conjunctive partitions. The output of disjunctive partitioner 28 may be input into model checker 32. Model checker 32 may be any suitable symbolic model checker, such as RuleBase.

The model produced by the hardware designer may have many forms. For example, every latch, flip-flop and/or transistor may be translated to a variable. Modeler 25 may then translate the hardware model to an EDL model with a random variable “proc_chooser” to model process chooser 24 and to asynchronously activate the variables. For example, for a latch with input ‘a’, output ‘p’ and a clock ‘clk’, modeler 25 may produce:

var p:Boolean;
assign init(p):=0;

next(p):=case

proc_chooser=current & clk: a;
else:p;

esac;

Conjunctive partitioner 26 may generate conjunctive partitions and _Rₓ(\overline{v},x′) for each state variable x of the model. Together with group definer 30, disjunctive partitioner 28 may generate a disjunctive partition for each group \overline{g} of state variables xᵢ from the conjunctive partitions.

To create the various disjunctive partitions, disjunctive partitioner 28 may store the dependent states of state variable x in a variable called dep_statesₓ(\overline{v}). By “dependent states” the present invention may refer to generally all of the states where a state variable x may change its value. Once the variable dep_statesₓ(\overline{v}) may be defined for all state variables x, disjunctive partitioner 28 may work through the state variables, selecting a state variable not yet assigned to a group of variables, having group definer 30 determine its group and then generating a disjunctive partition for the resultant group of state variables.

Initially, disjunctive partitioner 28 may determine the dependent states variable dep_statesₓ(v) from the conjunctive partitions and _Rₓ(\overline{v}, x′) by determining in which states a variable x can change its value (i.e. its next value is noted as x′). This is written mathematically as follows:
dep_{—}statesₓ(\overline{v})=∃x′(and _{—}Rₓ(\overline{v}, x′)=∃x≠x′)
where x≠x′ indicates that variable x changed its value.

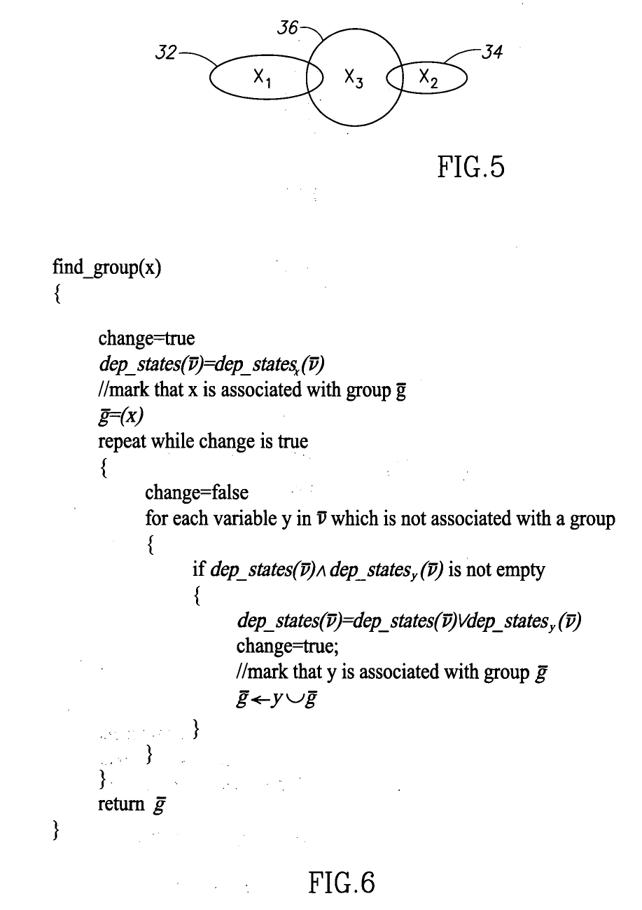

Group definer 30 may then repeatedly review the dependent states dep_statesₓ(\overline{v}) of the current state variable x to find all variables which may change if current state variable x may change. Reference is now briefly made to FIG. 5, which illustrates three circles 32, 34 and 36, representing dep_statesₓ(\overline{v}) for three variables x₁, x₂ and x₃, respectively. Thus, each circle may define the states in which the variable may change value. Circles 32 and 36 intersect, indicating that there are some states in which variables x₁ and x₃ both change values. Similarly, there are some states in which variables x₃ and x₂ change since circles 36 and 34 intersect. Thus, for the example of FIG. 5, variable x₁ relates to both variables x₂ and x₃ even though, the states in which variable x₁ changes with variable x₃ are not the same states that variable x₃ changes with variable x₂.

If group definer 30 checks whether x₁ and x₂ are in the same group before it checks whether x₁ and x₃ are in the same group, it will not find the relationship between x₁ and x₂ (since the latter is only seen through the intersection of variables x₁ and x₃). Therefore, group definer 30 generally may repeatedly pass through the variables until there is no change in the composition of the group. For k variables, there may be, at most, k−1 passes, and usually much less.

An exemplary pseudo-code for group definer 30 may be provided in FIG. 6 to which reference is now made. The pseudo-code of FIG. 6 may be one example of suitable code. Other code may be suitable and is included in the present invention.

In FIG. 6, after some initialization (in which the local dependent states variable dep_states(\overline{v}) is set to the one for the current variable x, the group \overline{g} is initialized to the current variable x and some other housekeeping tasks are done), a loop may be entered. At the beginning of the loop, a flag “change” may initially be set to false. It may be changed to true if, some time during a loop through all variables y in \overline{v} which are not yet associated with any other group, a new variable may be added to the group \overline{g}. The check for adding variable y may be:
if dep_states(\overline{v}) [symbol] dep_states_{y}(\overline{v}) is not empty

When the check is true, then the dependent states of variable y may be added to the local dependent states variable dep_states(\overline{v}), the flag “change” may be changed to true and variable y may be added to the group \overline{g}.

The process may continue until no more variables are added to group \overline{g}.

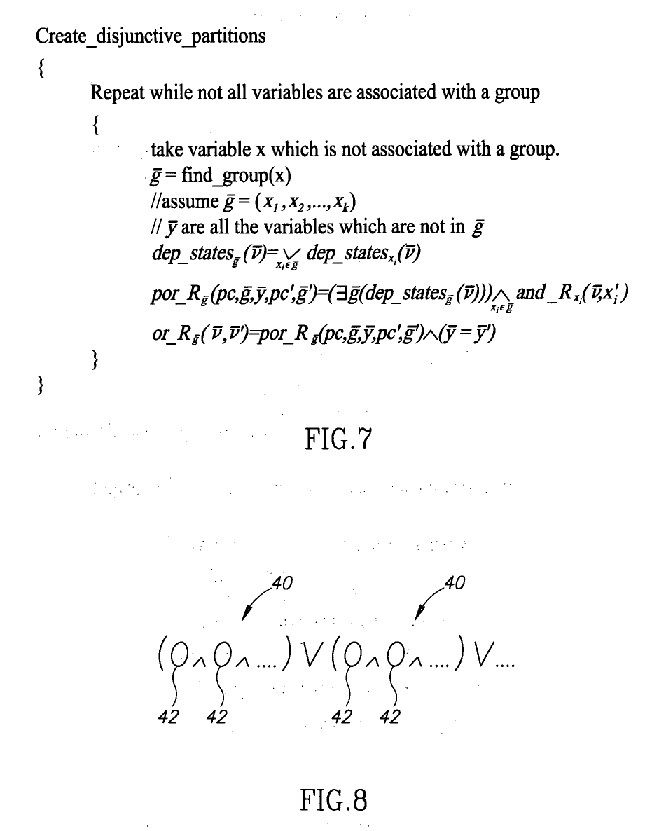

Reference is now made to FIG. 7, which illustrates an exemplary pseudo-code for disjunctive partitioner 28 (FIG. 4). The pseudo-code of FIG. 7 may be one example of suitable code. Other code may be suitable and is included in the present invention.

Disjunctive partitioner 28 may initially select variable x which may not yet be associated with a group. Partitioner 28 may instruct group definer 30 to find the group for state variable x and may then determine the dependent states for group \overline{g}, as being the disjunction of the dependent states of all of the variables in group \overline{g}, as follows:

$${dep\_states}_{\overline{g}} ( \overline{v} ) = {⋁}_{{x}_{i} ε \overline{g}} {dep\_states}_{{x}_{i}} ( \overline{v} )$$

Partitioner 28 may then conjoin the quantification of \overline{g} from dep_states_{g}(\overline{v}) with the conjunctive partitions and _Rₓᵢ(\overline{v},x′) of the variables xᵢ to generate a partial disjunctive partition por_R_{\overline{g}}(pc,\overline{g},\overline{y},pc′,\overline{g}′) which may store all the transitions which affect at least one of the variables of g, as follows:

$${por\_R}_{\overline{g}} ( pc , \overline{g} , \overline{y} , {pc}^{′} , {\overline{g}}^{′} ) = ( ∃ \overline{g} ( {dep\_states}_{\overline{g}} ( \overline{v} ) ) ) {⋀}_{{x}_{i} ε \overline{g}} {and\_R}_{{x}_{i}} ( \overline{v} , {x}_{i}^{′} )$$

It is noted that a disjunctive partition or _R_{\overline{g}}(\overline{v},\overline{v}′) for group \overline{g} may be generated by ANDing partial disjunctive partition por_R_{\overline{g}}(pc,\overline{g},\overline{y},pc′,\overline{g}′) with \overline{y}=\overline{y}′, where the latter indicates that the other variables do not change at the current time, as follows:
or_R_{\overline{g}}(\overline{v},\overline{v}′)=por—R_{\overline{g}}(pc,\overline{g},\overline{y},pc′,\overline{g}′) [symbol] (\overline{y}=\overline{y}′)

Model checker 32 (FIG. 4) may operate on disjunctive or partial disjunctive partitions. As discussed in U.S. patent application Ser. No. 10/925,022, filed Aug. 24, 2004, incorporated herein by reference, Applicants have realized that it may be sufficient to perform model checking on the partial disjunctive partitions rather than the disjunctive partitions, since the partial disjunctive partitions may store the information about the variables which transition at a given time. The additional information in the disjunctive partitions, that of \overline{y}=\overline{y}′, may not be necessary for the model checking operation.

However, frequently, there are too many variables in one group \overline{g}, and the resultant partial disjunctive partition may be too big. One solution, as shown in FIG. 8 to which reference is briefly made, may be to utilize the “disjunctive normal form” (DNF). FIG. 8 shows a multiplicity of partial disjunctive partitions 40, one per group \overline{g}, Or'ed together. In accordance with a preferred embodiment of the present invention, each partial disjunctive partition 40 may be further partitioned into a plurality of small conjunctive partitions 42 to be conjoined (i.e. ANDed together). Mathematically, the DNF may be written as the disjunction of partial disjunctive partitions 40, each of which is a list por_R_{\overline{g}_list(pc,\overline{g},\overline{y},pc′,\overline{g}′) of conjunctive partitions 42, as follows:}

$$TR = {⋁}_{\overline{g} εG} {por\_R}_{\overline{g}} \_list ( pc , \overline{g} , \overline{y} , {pc}^{′} , {\overline{g}}^{′} )$$

where, for each \overline{g}=(x₁,x₂, . . . ,xₖ), \overline{g}εG,

$${por\_R}_{\overline{g}} \_list ( pc , \overline{g} , \overline{y} , {pc}^{′} , {\overline{g}}^{′} ) = ( \begin{matrix}∃ \overline{g} ( {dep\_states}_{\overline{g}} ( \overline{v} ) ) , {and\_R}_{{x}_{1}} ( \overline{v} , {x}_{1}^{′} ) , \\ {and\_R}_{{x}_{2}} ( \overline{v} , {x}_{2}^{′} ) , … , {and\_R}_{{x}_{k}} ( \overline{v} , {x}_{k}^{′} )\end{matrix} )$$

It will be appreciated that adding \overline{y}=\overline{y}′ to por_R_{\overline{g}}(pc,\overline{g},\overline{y},pc′,\overline{g}′) may provide a DNF transition relation.

It will also be appreciated that a simple conjunctive partitioning of each partial disjunctive partition por_R_{\overline{g}}(pc,\overline{g},\overline{y},pc′,\overline{g}′) may be to list the elements of partial disjunctive partition por_R_{\overline{g}}(pc,\overline{g},\overline{y},pc′,\overline{g}′) that originally were conjoined to create partial disjunctive partition por_R_{\overline{g}}(pc,\overline{g},\overline{y},pc′,\overline{g}′).

In another embodiment, each state machine in the asynchronous hardware may be one group. There may be conjunctive partitioning for the variables of each state machine and there may be disjunction between the state machines.

The image computation using the partial disjunctive normal form may operate on the conjunctive partitions 42 first (to generate a result for one partial disjunctive partition 40 for one group \overline{g}) and may then union the results of the partial disjunctive partitions 40, to generate the results for all variables x.

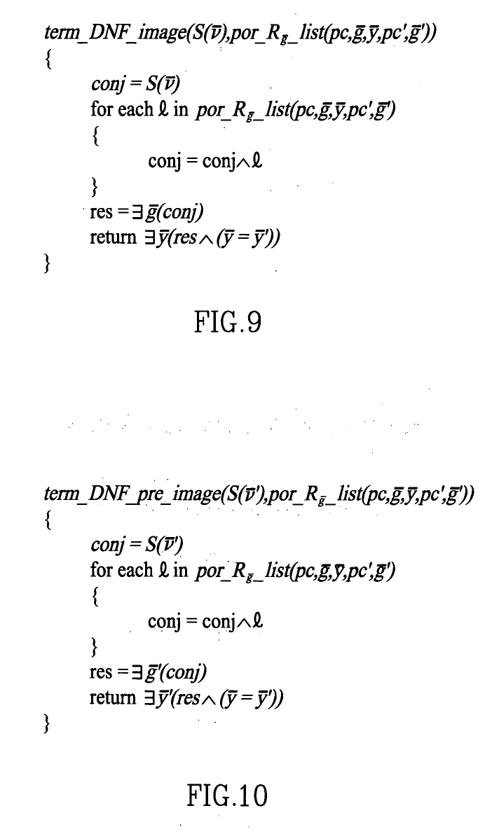

Reference is now made to FIG. 9, which is exemplary pseudo-code, termed term_DNF_image, for one term of an image computation, for one group \overline{g}. Subroutine term_DNF_image may operate on the list of conjunctive partitions 42 for one group \overline{g}. In accordance with the present invention, the group of states S(\overline{v}) may be conjuncted with the first element l in the list por_R_{\overline{g}}list(pc,\overline{g},\overline{y},pc′,\overline{g}′) and the result, a BDD conj, may be conjuncted with the second element l in the list por_R_{\overline{g}}list(pc,\overline{g},\overline{y},pc′,\overline{g}′), etc, until the list por_R_{\overline{g}}_{_{—}}list(pc,\overline{g},\overline{y},pc′,\overline{g}′) may be finished.

Once list por_R_{\overline{g}}_{_{—}}list(pc,\overline{g},\overline{y},pc′,\overline{g}′) may be finished, an exist operation may be performed, producing a variable res, to determine if the group \overline{g} exists in the final BDD conj, representing the partial disjunctive partition 40. Finally, the non-changing variables \overline{y} are renamed \overline{y}′ (via an exist operation) by conjoining \overline{y}=\overline{y}′ with the output of the first exist operation.

An analogous operation may be performed for the pre-image computation, shown in FIG. 10, to which reference is now made. The computation here is termed term_DNF_pre_image. In term_DNF_pre_image, the variable conj may be initialized with the next step group of states S(\overline{v}′) and the rename operations may be performed for the group \overline{g}′ at the next step and the other variables \overline{y}′ at the next step.

It will be appreciated that the rename operation of the present invention may be implemented in many different ways, including ones which are linear in the size of the BDD. Moreover, term_DNF_pre_image and term_DNF_image can be made more efficient by methods like early quantification and simplify assuming, such as those described in the following articles:
D. Geist and I. Beer. Efficient Model Checking By Automated Ordering Of Transition Relation Partitions. In Proc. 6^{th} International Conference on Computer Aided Verification (CAV), LNCS 818, pages 299-310. Springer-Verlag, 1994.
K. Ravi, K. McMillan, T. Shiple, and F. Somenzi, “Approximation and decomposition of binary decision diagrams,” in Proc. Design Automation Conf., 1998, pp. 445-450.

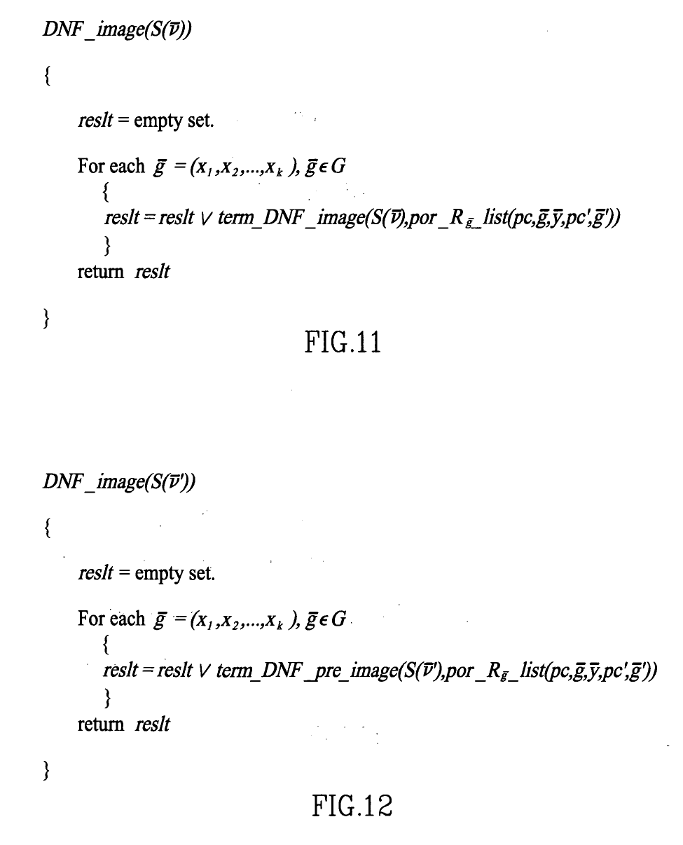

The DNF image computation may take the results for each group \overline{g} and may disjunct them. This may be seen in FIG. 11, to which reference is now made. The output of term_DNF_image for a current group \overline{g} may be Or'ed with the output of a previous group \overline{g}, starting from the empty set and finishing with the last group \overline{g}. The resultant BDD, called reslt, may be the image for the entire set of variables x for the hardware of interest.

An analogous operation, shown in FIG. 12 to which reference is now briefly made, may be performed for the pre-image computation. In this exemplary pseudo-code, the output of term_DNF_pre_image for a current group \overline{g} may be Or'ed with the output of a previous group g, starting from the empty set and finishing with the last group g. The resultant BDD, also called reslt, may be the pre-image for the entire set of variables x for the hardware of interest.

As is known in the art, the image and pre-image of the present invention may be used for various model checking tasks, such as reachability.

Returning to FIG. 3B, if there is any behavior to process chooser 24 (deterministic or otherwise), it may be modeled appropriately and a conjunctive partition and _R_{pc}(\overline{v}, pc′) may be generated. The disjunctive partition and list may then be calculated as follows to incorporate the behavior of process chooser 24:

$$\begin{matrix}{por\_R}_{\overline{g}} ( pc , \overline{g} , \overline{y} , {pc}^{′} , {\overline{g}}^{′} ) = ( ∃ \overline{g} ( {dep\_states}_{\overline{g}} ( \overline{v} ) ) ) {⋀}_{{x}_{i} ε \overline{g}} {and\_R}_{{x}_{i}} ( \overline{v} , {x}_{i}^{′} ) \\ ⋀ {and\_R}_{pc} ( \overline{v} , {pc}^{′} )\end{matrix}$$

$${por\_R}_{\overline{g}} \_list ( pc , \overline{g} , \overline{y} , {pc}^{′} , {\overline{g}}^{′} ) = ( \begin{matrix}∃ \overline{g} ( {dep\_states}_{\overline{g}} ( \overline{v} ) ) , {and\_R}_{{x}_{1}} ( \overline{v} , {x}_{1}^{′} ) , \\ {and\_R}_{{x}_{2}} ( \overline{v} , {x}_{2}^{′} ) , … , {and\_R}_{{x}_{k}} ( \overline{v} , {x}_{k}^{′} ) , \\ {and\_R}_{pc} ( \overline{v} , {pc}^{′} ) \end{matrix} )$$

In addition, a partial disjunctive partition for the process chooser pc may be generated which may store any not already modeled activity of the hardware. First, a variable dep_pcsₓ(pc) may be generated which may store the values of process chooser pc to which some other variable responds. The values stored in dep_pcsₓ(pc) may be ones which are already related to another variable and thus, do not require modeling in the disjunctive partition of process chooser pc. The calculation for dep_pcsₓ(pc) may be:
1. Calculate dep_pcsₓ(pc) for each x≠pc:
   dep_{—}pcsₓ(pc)=dep_{—}statesₓ(\overline{v})|_{pc}
   where A|_{\overline{x}} indicates the projection of the set A onto a set of variables \overline{x}.
2. Calculate the set of pc values leftover_pcs(pc) for which no variable changes as a function of them:

$$leftover\_pcs ( pc ) = {⋀}_{x \neq pc} ( \overline{{dep\_pcs}_{x} ( pc )} )$$
3. Intersect conjunctive partition and _R_{pc}(\overline{v}, pc′) with the set leftover_pcs(pc) to get the value of pc′ for the current pc value in a partial disjunctive partition por_R_{pc}(pc,x,\overline{y},pc′):
   por_{—}R_{pc}(pc, x, \overline{y}, pc′)=leftover_{—}pcs(pc) [symbol] and _{—}R_{pc}(\overline{v}, pc′)

While certain features of the invention have been illustrated and described herein, many modifications, substitutions, changes, and equivalents will now occur to those of ordinary skill in the art. It is, therefore, to be understood that the appended claims may be intended to cover all such modifications and changes as fall within the true spirit of the invention.

What is claimed is:

1. A method comprising:
generating a model of a piece of generally asynchronous hardware, wherein in said model, the set of variables includes a separate process chooser variable and the remainder of the variables are divided into disjoint sets of groups, wherein at each cycle of the model, the process chooser and maximally, variables from one group of variables change values.

2. The method of claim 1 and also comprising partitioning said model into disjunctive partitions, one per group.

3. The method of claim 1 and also comprising partitioning said model into partial disjunctive partitions, one per group.

4. The method of claim 1 and also comprising partitioning said model into a disjunctive normal form partition with one term for each group.

5. The method of claim 1 and also comprising partitioning said model into a partial disjunctive normal form partition with one term for each group.

6. The method according to claim 3 and also comprising computing at least one of an image and a pre-image using said partial disjunctive partitions.

7. The method according to claim 5 and also comprising computing at least one of an image and a pre-image using said partial disjunctive normal form.

8. A computer product readable by a machine, tangibly embodying a program of instructions executable by the machine to perform method steps for model checking, said method steps comprising:
generating a model of a piece of generally asynchronous hardware, wherein, in said model, the set of variables includes a separate process chooser variable and the remainder of the variables are divided into disjoint sets of groups, wherein at each cycle of the model, the process chooser and maximally, variables from one group of variables change values.

9. The product of claim 8 and also comprising partitioning said model into disjunctive partitions, one per group.

10. The product of claim 8 and also comprising partitioning said model into partial disjunctive partitions, one per group.

11. The product of claim 8 and also comprising partitioning said model into a disjunctive normal form partition with one term for each group.

12. The product of claim 8 and also comprising partitioning said model into a partial disjunctive normal form partition with one term for each group.

13. The product according to claim 10 and also comprising computing at least one of an image and a pre-image using said partial disjunctive partitions.

14. The product according to claim 12 and also comprising computing at least one of an image and a pre-image comprises using said partial disjunctive normal form for said partial disjunctive partitions.

15. A model checker comprising:
a model generator to generate a model of a piece of generally asynchronous hardware, wherein in said model, the set of variables includes a separate process chooser variable and the remainder of the variables are divided into disjoint sets of groups, wherein at each cycle of the model, the process chooser and maximally, variables from one group of variables change values.

16. The model checker of claim 15 and also comprising a partitioner to partition said model into disjunctive partitions, one per group.

17. The model checker of claim 15 and also comprising a partitioner to partition said model into partial disjunctive partitions, one per group.

18. The model checker of claim 15 and also comprising a partitioner to partition said model into a disjunctive normal form partition with one term for each group.

19. The model checker of claim 15 and also comprising a partitioner to partition said model into a partial disjunctive normal form partition with one term for each group.

20. The model checker according to claim 17 and also comprising a checker to compute at least one of an image and a pre-image using said partial disjunctive partitions.

21. The model checker according to claim 19 and also a checker to compute at least one of an image and a pre-image comprises using said partial disjunctive normal form for said partial disjunctive partitions.
